(19) United States
(12) Patent Application Publication
(10) Pub. No.: US 2007/0243323 A1
(43) Pub. Date: Oct. 18, 2007

(54) Method for Manufacturing a Cube-Corner Typed Retroreflective Element and The Said Retroreflective Element

(75) Inventor: Hyen Dae Kim, Gyeonggi-do (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: Reflomax Co., Ltd., Seoul (KR)

(21) Appl. No.: 11/570,259

(22) PCT Filed: Jun. 10, 2005
(86) PCT No.: PCT/KR05/01770

§ 371 Date: Jan. 9, 2007

(30) Foreign Application Priority Data
Jun. 11, 2004 (KR) 10-2004-0042974

(51) Int. Cl. G02B 5/12

(52) U.S. Cl. 427/163.1; 359/530

(57) ABSTRACT

The object of this invention is to provide a method of manufacturing a cube-corner type retroreflective element and a cube-corner type retroreflective element manufactured thereby. The method of the current invention includes (a) laminating a thermosetting resin having a predetermined thickness on an upper surface of a base film (200), and then forming a plurality of triangular pyramidal cube-corner type retroreflectors (101), each of which has three congruent surfaces, other than a retroreflective surface attached to the base film; (b) coating the three surfaces, other than the retroreflective surface, of each of the plurality of cube-corner type retroreflectors (101) formed on the base film (200) with a metal film (C) having a predetermined thickness, to manufacture a plurality of cube-corner type retroreflective elements (100); and (c) stripping the cube-corner type retroreflective elements (100) from the base film (200) , and then individually collecting the cube-corner type retroreflective elements.

### TECHNICAL FIELD

The present invention relates, in general, to a method of manufacturing a cube-corner type retroreflective element, and a cube-corner type retroreflective element manufactured thereby. More particularly, the present invention relates to a method of manufacturing a cube-corner type retroreflective element, comprising coating three total reflection surfaces in a cube-corner type element, having retroreflective properties causing incident light and reflected light to be parallel to each other, with a metal film, to retroreflect incident light entering one surface that is not coated with the metal film, even in water or other transparent liquid, thereby forming reflected light that is parallel to incident light; and to a cube-corner type retroreflective element manufactured thereby.

### BACKGROUND ART

Generally, elements having retroreflective properties are exemplified by a bead type element and a cube-corner type prismatic element.

Regarding the bead type element, many patents including ‘method of transferring glass beads’ disclosed in Korean Patent Application Laid-open Publication No. 2001-0007989 have been applied for and registered.

The method of transferring glass beads comprises steps of (a) applying a mixture comprising silicone, a solvent and a silicone additive on transfer paper using screen printing; (b) applying a mixture comprising glass beads and a solvent or a transparent liquid on the silicone layer formed in the step (a) using screen printing; (c) selecting ink of a desired color, which is then screen printed on the glass bead layer formed in the step (b); (d) applying an adhesive on the ink layer formed in the step (c) using screen printing, to prepare a printing material; and (e) transferring the printing material prepared in the step (d) to an objective using a heat press.

However, the method of transferring glass beads, other bead type elements, and general cube-corner type prismatic elements are disadvantageous because the above-mentioned elements vary in refractive index when water, impurities or transparent liquid adhere thereto, resulting in lost retroreflective properties.

### DISCLOSURE OF THE INVENTION

Accordingly, the present invention has been made keeping in mind the above problems occurring in the prior art, and an object of the present invention is to provide a method of manufacturing a cube-corner type retroreflective element, comprising coating three surfaces of a cube-corner type retroreflector formed on a base film having high elongation with a metal film, and then elongating the base film to strip a cube-corner type retroreflective element coated with the metal film from the base film, which is advantageous because the three surfaces of the element are coated with the metal film, and retroreflective properties thereof are maintained even when water, impurities or transparent liquid adhere thereto.

Another object of the present invention is to provide a cube-corner type retroreflective element manufactured thereby.

In order to accomplish the above objects, the present invention provides a method of manufacturing a cube-corner type retroreflective element, comprising steps of (a) laminating a thermosetting resin having a predetermined thickness on an upper surface of a base film, and then forming the laminated thermosetting resin into a plurality of triangular pyramidal cube-corner type retroreflectors, each of which has three congruent surfaces, other than a retroreflective surface attached to the base film; (b) coating the three surfaces, other than the retroreflective surface, of each of the plurality of cube-corner type retroreflectors formed on the base film with a metal film having a predetermined thickness, to manufacture a plurality of cube-corner type retroreflective elements; and (c) stripping the cube-corner type retroreflective elements from the base film, and then individually collecting the cube-corner type retroreflective elements.

Preferably, the base film may be formed of a thermoplastic plastic material having high elongation.

More preferably, the thermoplastic plastic material may be PVC, TPU, or PO.

In addition, preferably, the step (a) may include applying a slip additive on the base film, and then laminating the thermosetting resin.

In addition, preferably, the step (a) may include patterning the laminated thermosetting resin using a metal pattern, to form the plurality of cube-corner type retroreflectors.

In addition, the metal film is preferably formed of aluminum, nickel, chromium, silver or copper.

In addition, the metal film is preferably 500 Å to 1000 Å thick.

In addition, preferably, the step (c) may include elongating the base film to strip the cube-corner type retroreflective elements.

In addition, preferably, the method may further include forming an oxidation prevention film on the metal film to prevent the metal film from oxidizing, after the step (b).

More preferably, the oxidation prevention film may be formed by spraying or applying an oxidation prevention liquid onto the cube-corner type retroreflective elements attached to the base film, and then drying it.

Further, the present invention provides a cube-corner type retroreflective element, manufactured by (A) laminating a thermosetting resin having a predetermined thickness on an upper surface of a base film, and then forming the laminated thermosetting resin into a plurality of triangular pyramidal cube-corner type retroreflectors, each of which has three congruent surfaces, other than a retroreflective surface attached to the base film; (B) coating the three surfaces, other than the retroreflective surface, of each of the plurality of cube-corner type retroreflectors formed on the base film with a metal film having a predetermined thickness, to manufacture a plurality of cube-corner type retroreflective elements; and (C) stripping the cube-corner type retroreflective elements from the base film, and then individually collecting the cube-corner type retroreflective elements.

Preferably, the plurality of cube-corner type retroreflectors each have three congruent surfaces having triangle shapes, in which the triangle shape is an isosceles triangle having a right angle between oblique sides and 45° between the oblique side and a bottom side.

More preferably, the height (height to the retroreflective surface from an apex) of the cube-corner type retroreflector may range from 50 to 700 μm.

Further, the present invention provides a cube-corner type retroreflective element, manufactured by (A′) laminating a thermosetting resin having a predetermined thickness on an upper surface of a base film, and then forming the laminated thermosetting resin into a plurality of square pyramidal cube-corner type retroreflectors, each of which has congruent surfaces, other than a retroreflective surface attached to the base film; (B′) coating the surfaces, other than the retroreflective surface, of each of the plurality of cube-corner type retroreflectors formed on the base film with a metal film having a predetermined thickness, to manufacture a plurality of cube-corner type retroreflective elements; and (C′) stripping the cube-corner type retroreflective elements from the base film, and then individually collecting the cube-corner type retroreflective elements.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart showing the process of manufacturing a cube-corner type retroreflective element, according to the present invention;

FIG. 2 is a sectional view showing a plurality of cube-corner type retroreflectors formed on a base film, according to the present invention;

FIG. 3 is a sectional view showing a plurality of cube-corner type retroreflective elements formed on a base film, according to the present invention;

FIG. 4 is a plan photograph showing the plurality of cube-corner type retroreflective elements, manufactured according to the present invention;

FIG. 5 is a plan photograph showing the structure of the cube-corner type retroreflective elements, according to the present invention;

FIG. 6 is a sectional view showing the cube-corner type retroreflective elements each having an oxidation prevention film, according to the present invention; and

FIG. 7 is a conceptual view showing the collection of the cube-corner type retroreflective elements using a collector, according to the present invention.

### BEST MODE FOR CARRYING OUT THE INVENTION

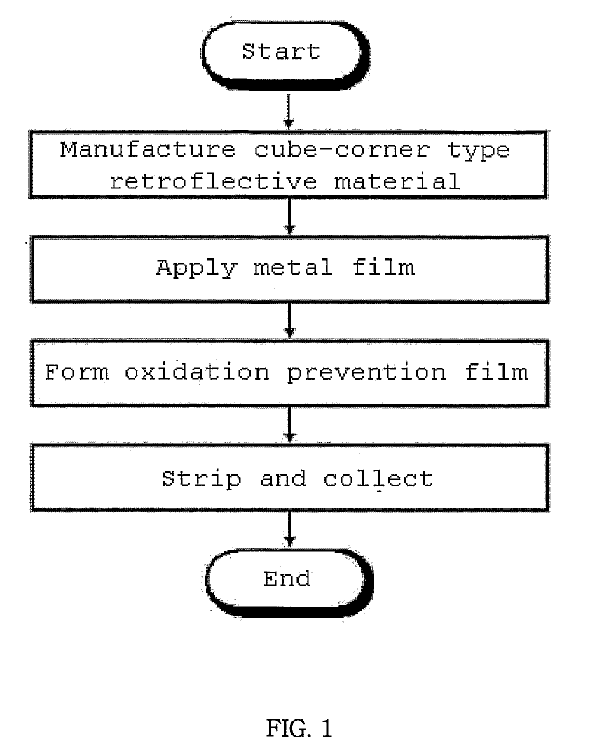

Hereinafter, a detailed description will be given of a method of manufacturing a cube-corner type retroreflective element, according to the present invention, with reference to FIGS. 1 to 7.

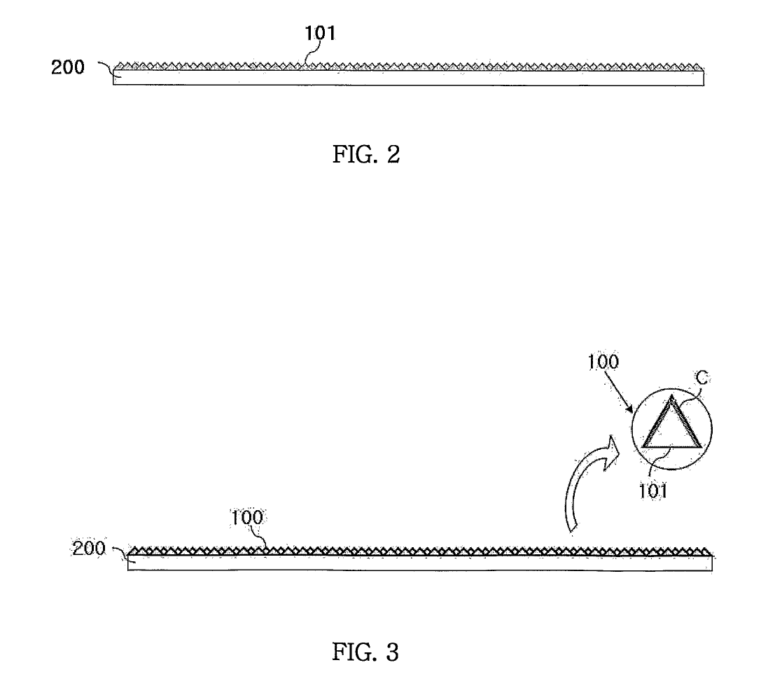

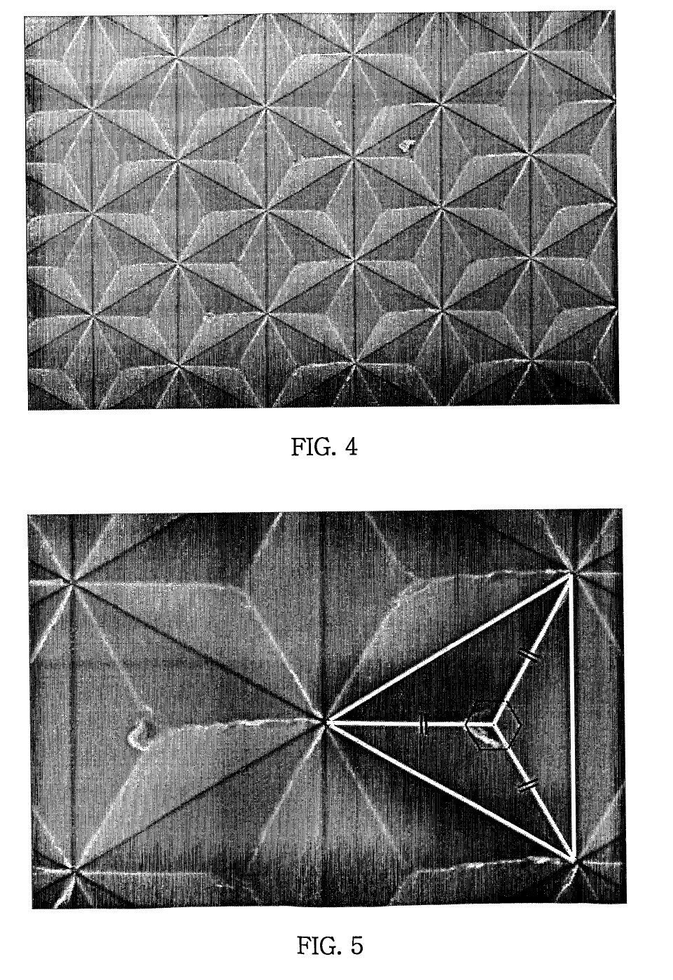

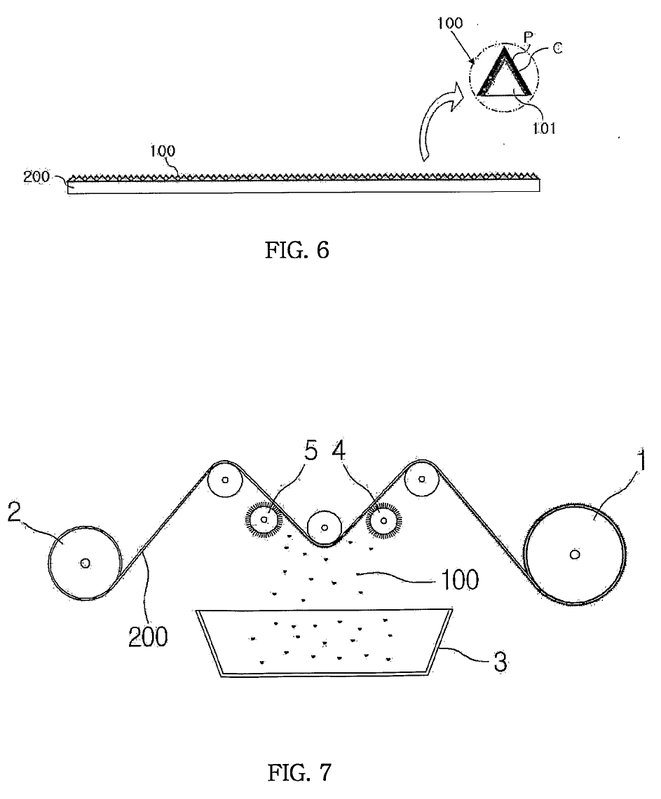

FIG. 1 is a flowchart showing the process of manufacturing a cube-corner type retroreflective element according to the present invention, FIG. 2 is a sectional view showing a plurality of cube-corner type retroreflectors formed on a base film according to the present invention, FIG. 3 is a sectional view showing a plurality of cube-corner type retroreflective elements formed on a base film according to the present invention, FIG. 4 is a plan photograph showing the plurality of cube-corner type retroreflective elements manufactured according to the present invention, FIG. 5 is a plan photograph showing the structure of the cube-corner type retroreflective elements according to the present invention, FIG. 6 is a sectional view showing the cube-corner type retroreflective elements each having an oxidation prevention film according to the present invention, and FIG. 7 is a view showing the collection of the cube-corner type retroreflective elements using a collector according to the present invention.

[First Process] Manufacture of Cube-Corner Type Retroreflector

On the upper surface of a base film 200 which is formed of a thermoplastic plastic material including PVC (Poly Vinyl Chloride), TPU (Thermo Poly Urethane) or PO (Poly Olephin), a thermosetting resin having a predetermined thickness is laminated. Then, the laminated thermosetting resin is patterned using a metal pattern, thereby forming a plurality of triangular pyramidal cube-corner type retroreflectors 101, each of which has three congruent surfaces having isosceles triangle shapes, other than a bottom surface (hereinafter, called a ‘retroreflective surface’) attached to the base film 200, as shown in FIG. 2.

In the present invention, the base film 200 is formed of PVC (Poly Vinyl Chloride), TPU (Thermo Poly Urethane) or PO (Poly Olephin). However, the present invention is not limited thereto. For example, any thermoplastic plastic material may be used, as long as the cube-corner type retroreflective elements may easily be stripped therefrom, due to high elongation thereof, in the subsequent stripping and collecting process.

In addition, the thermosetting resin is directly laminated on the base film 200 in the present invention. However, the present invention is not limited thereto. For example, to easily perform the subsequent stripping process, a slip additive may be applied on the base film 200, after which the thermosetting resin may be laminated thereon.

In addition, the cube-corner type retroreflectors 101 each have a triangular pyramidal shape in the present invention. However, the present invention is not limited thereto. For example, the cube-corner type retroreflector may have a square pyramidal shape.

[Second Process] Application of Metal Film

Subsequently, as shown in FIGS. 3 and 4, aluminum is applied to a thickness from 500 Å to 1000 Å on surfaces of each of the plurality of cube-corner type retroreflectors 101 formed on the base film 200, via vacuum deposition, so that the above-mentioned three surfaces, other than the retroreflective surface, are coated with aluminum, to manufacture a plurality of cube-corner type retroreflective elements 100.

The metal film C formed of aluminum functions to retroreflect incident light entering the retroreflective surface to form reflected light parallel to incident light.

The metal film is formed of aluminum in the present invention. However, the present invention is not limited thereto. For example, the metal film may be formed of a metal, such as copper, nickel, chromium, silver, etc.

As shown in FIG. 5, each of the three surfaces having triangle shapes in the cube-corner type retroreflective element, according to the present invention, is formed in an isosceles triangle having a right angle between oblique sides and 45° between the oblique side and a bottom side.

The height (height to the retroreflective surface from an apex) of each of the cube-corner type retroreflectors including the three surfaces having triangle shapes, according to the present invention, ranges from 50 to 700 μm, and preferably is 500 μm.

[Third Process] Formation of Oxidation Film

In each of the cube-corner type retroreflective elements 100, the metal film C has oxidation properties. Thus, to prevent the metal film C from oxidation, an oxidation prevention film P is formed on the metal film C, as shown in FIG. 6.

In the present invention, the oxidation prevention film P is formed by spraying or applying an oxidation prevention liquid onto the cube-corner type retroreflective elements 100 attached to the base film 200, and then drying it. However, the present invention is not limited thereto.

When forming the oxidation prevention film, a colorant having a color suitable for end uses of the element may be added to the prevention liquid, to vary the color of the element. Although the color of the element varies slightly with the metal used, it is mainly metallic and dark, which differs from the color of a traffic lane or a road traffic sign to be painted with a light color, such as white or yellow. Therefore, with the goal of improving the above problem, the colorant may be added to the oxidation prevention liquid, so that the element may be appropriately colored for end uses.

Each of the cube-corner type retroreflective elements 100, having undergone the above process of forming an oxidation prevention film, is disadvantageous because the surface of the metal film C may be electrically conductive. Due to the electrical conductivity, the metal film C may break down upon cutting the base film 200.

The present applicant has solved the problems caused by the electrical conductivity of the surface of the metal film, by randomly forming cube corners using an embossing roller, thus randomly arranging the cube corners, as disclosed in Korean Patent Application No. 10-2004-0004315 (a cube-corner type reflective sheet having a metal film and a method of manufacturing the same).

Unlike the above Patent Application by the present applicant, in the present invention, the above problems are solved using the elongation of the base film 200 and weak bondability between the cube-corner type retroreflective elements. Further, the cube-corner type retroreflective element of the present invention may be more widely applied, which is described as follows.

[Fourth Process] Stripping and Collecting

Finally, to strip the cube-corner type retroreflective elements 100, having undergone the above process of forming the oxidation film, from the base film 200 and collect them, the base film 200 which has the cube-corner type retroreflective elements 100 attached thereto is mounted to an unwinding portion 1 and a winding portion 2 of a collector, as shown in FIG. 7, according to the present invention. Upon operating the collector, while the base film 200 having high elongation is elongated, it begins to be wound onto the winding portion 2.

When the base film 200 is elongated, the cube-corner type retroreflective elements 100 are first stripped from the base film 200. In addition, the cube-corner type retroreflective elements 100 are stripped from each other due to weak bondability therebetween. Thereby, the retroreflective elements are individually collected in a collection container 3.

The retroreflective elements which have not been stripped in the first stripping procedure are additionally stripped from the base film 200, using a first brush 4 and a second brush 5, and then collected in the collection container 3.

By performing the above process, the cube-corner type retroreflective elements, in which three surfaces, other than the retroreflective surface, are coated with the metal film C to form reflective light parallel to incident light entering the retroreflective surface, may be individually manufactured and collected. Therefore, the cube-corner type retroreflective element of the present invention may be more widely applied than stripe type retroreflective elements.

### INDUSTRIAL APPLICABILITY

As described above, the present invention provides a method of manufacturing a cube-corner type retroreflective element and a cube-corner type retroreflective element manufactured thereby. In the cube-corner type retroreflective element of the present invention, three surfaces, other than the retroreflective surface, are coated with a metal film. Therefore, the cube-corner type retroreflective elements, which are able to maintain retroreflective properties even when water, impurities or transparent liquid adhere thereto, can be individually manufactured and collected, and thus, be more widely applied.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A method of manufacturing a cube-corner type retroreflective element, comprising steps of:
(a) laminating a thermosetting resin having a predetermined thickness on an upper surface of a base film, and then forming the laminated thermosetting resin into a plurality of triangular pyramidal cube-corner type retroreflectors, each of which has three congruent surfaces, other than a bottom surface (hereinafter, called a ‘retroreflective surface’) attached to the base film;
(b) coating the three surfaces, other than the retroreflective surface, of each of the plurality of cube-corner type retroreflectors formed on the base film with a metal film having a predetermined thickness, to manufacture a plurality of cube-corner type retroreflective elements; and
(c) stripping the cube-corner type retroreflective elements from the base film, and then individually collecting the cube-corner type retroreflective elements.

2. The method according to claim 1, wherein the base film is formed of a thermoplastic plastic material having high elongation.

3. The method according to claim 2, wherein the thermoplastic plastic material is PVC (Poly Vinyl Chloride), TPU (Thermo Poly Urethane), or PO (Poly Olephin).

4. The method according to claim 1, wherein the step (a) includes applying a slip additive on the base film, and then laminating the thermosetting resin.

5. The method according to claim 1, wherein the step (a) includes patterning the laminated thermosetting resin using a metal pattern, to form the plurality of cube-corner type retroreflectors.

6. The method according to claim 1, wherein the metal film is formed of aluminum, nickel, chromium, silver or copper.

7. The method according to claim 1, wherein the metal film is 500 to 1000 Å thick.

8. The method according to claim 1, wherein the step (c) includes elongating the base film to strip the cube-corner type retroreflective elements.

9. The method according to claim 1, further comprising forming an oxidation prevention film on the metal film to prevent the metal film from oxidation, after the step (b).

10. The method according to claim 9, wherein the oxidation prevention film is formed by spraying or applying an oxidation prevention liquid onto the cube-corner type retroreflective elements attached to the base film, and then drying it.

11. A cube-corner type retroreflective element, manufactured by (A) laminating a thermosetting resin having a predetermined thickness on an upper surface of a base film, and then forming the laminated thermosetting resin into a plurality of triangular pyramidal cube-corner type retroreflectors, each of which has three congruent surfaces, other than a bottom surface (hereinafter, called a ‘retroreflective surface’) attached to the base film;
(B) coating the three surfaces, other than the retroreflective surface, of each of the plurality of cube-corner type retroreflectors formed on the base film with a metal film having a predetermined thickness, to manufacture a plurality of cube-corner type retroreflective elements; and
(C) stripping the cube-corner type retroreflective elements from the base film, and then individually collecting the cube-corner type retroreflective elements.

12. The cube-corner type retroreflective element according to claim 11, wherein each of the plurality of cube-corner type retroreflectors has three congruent surfaces having triangle shapes, and
the triangle shape is an isosceles triangle having a right angle between oblique sides and 45° between the oblique side and a bottom side.

13. The cube-corner type retroreflective element according to claim 11 or 12, wherein a height (a height to the retroreflective surface from an apex) of the cube-corner type retroreflector ranges from 50 to 700 μm.

14. A cube-corner type retroreflective element, manufactured by (A′) laminating a thermosetting resin having a predetermined thickness on an upper surface of a base film, and then forming the laminated thermosetting resin into a plurality of square pyramidal cube-corner type retroreflectors, each of which has congruent surfaces, other than a retroreflective surface attached to the base film;
(B′) coating the surfaces, other than the retroreflective surface, of each of the plurality of cube-corner type retroreflectors formed on the base film with a metal film having a predetermined thickness, to manufacture a plurality of cube-corner type retroreflective elements; and
(C′) stripping the cube-corner type retroreflective elements from the base film, and then individually collecting the cube-corner type retroreflective elements.
